(19) United States
(12) Patent Application Publication
(10) Pub. No.: US 2009/0061177 A1
(43) Pub. Date: Mar. 5, 2009

(54) METHOD OF PRINTING USING HIGH PERFORMANCE TWO-COMPONENT REACTIVE INKS AND COATINGS WITH FLEXOGRAPHIC PRINTING PROCESSES

(76) Inventors: James A. Kriha, Neenah, WI (US); David Christopher Ward, Appleton, WI (US)

Correspondence Address: BANNER & WITCOFF, LTD., TEN SOUTH WACKER DRIVE, SUITE 3000, CHICAGO, IL, 60606, US

(21) Appl. No.: 12/195,203

(22) Filed: Aug. 20, 2008

Related U.S. Application Data
(60) Provisional application No. 60/968,982, filed on Aug. 30, 2007.
(60) Provisional application No. 61/082,085, filed on Jul. 18, 2008.

(51) Int. Cl. B32B 3/00; B44C 5/00; B05D 5/00

(52) U.S. Cl. 428/209; 428/211.1; 428/195.1; 427/287; 427/288; 427/256

(57) ABSTRACT

A printed article prepared by a flexographic printing process by applying a coating or ink that contains materials that are highly reactive with hydroxyl groups to an article substrate using a flexographic roller or plate made of non-polar polymers and optionally impregnated with silicone. In addition, a flexographic process for preparing a printed article by pattern applying more than one type of coating onto an article substrate. Unique patterns are laser engraved onto non-polar polymeric flexographic rollers/plates that may be impregnated with silicone, to preferably each coat different portions of the article substrate surface.

### CROSS REFERENCE TO RELATED APPLICATIONS

This application claims priority to provisional U.S. Application Ser. No. 60/968,982, filed Aug. 30, 2007, and to provisional U.S. Application Ser. No. 61/082,085, filed Jul. 18, 2008, which are both incorporated herein by reference in their entireties. This application is related to copending nonprovisional U.S. application Ser. No. ______, filed ______, incorporated herein by reference in its entirety.

### FIELD OF THE INVENTION

The invention relates to methods of printing using inks and coatings that are highly reactive with materials containing hydroxyl groups, such as alcohols or water. The invention further relates to printed articles prepared by a flexographic process that includes inks and coatings that are very reactive with hydroxyl groups. In addition, the invention relates to systems for printing articles with both inks and coatings that react with hydroxyl groups and inks and coatings that are not reactive with hydroxyl groups.

### BACKGROUND OF THE INVENTION

For flexible packaging it is necessary to have consumer information and brand identification printed on the outside of the package that can be easily seen. Good quality graphic color printing is required for aesthetics and marketing. This type of printing is required to obtain an adequate print quality expected in today's packaging industry, to provide good scuff resistance so the print does not rub off, and to obtain sufficient heat resistance for packages that are heat sealed. Historically there were two different methods for printing packages.

A first method reverse printed the outer package film and then laminated this outer film to the film structure used for the package. A second and more economical way printed on the surface of the package film structure and then applied an over print varnish (OPV) to protect the printing from rubbing off and to have adequate heat resistance properties so the film could be heat sealed.

When surface printing, inks that are highly reactive with hydroxyl groups were used and an over print varnish (OPV) was applied using a rotogravure method. This method gave good quality printed images and also protected the printing so that the printing would not rub off during the manufacturing, shipping and handling of the packages. Also during the manufacturing of the package, the film was heat sealed and because there was adequate heat resistance, the print would not come off and adhere to the heat sealing jaws of the packaging machine, causing a buildup of ink residue.

There are two main types of printing processes, rotogravure and flexographic printing, used in flexible packaging. A rotogravure printing method was required when using such inks that react with hydroxyl groups because the inks were prepared in non-hydroxyl-containing solvents, such as esters and ketones. Known rollers and plates used in flexographic printing were incompatible with these solvents, for example acetate based inks. Rotogravure printing is a considerably more expensive printing method for the small size of printing runs that can sometimes occur for flexible packaging applications. Further, there is the offset gravure printing process, which includes a combination of rotogravure and flexographic printing rollers and plates.

Ink supplier Siegwerk produces 2-component ink & over print varnish (OPV) technology. A particular 2-component ink/OPV includes a hardener having polymer isocyanates and a binder having a modified polyvinyl chloride (PVC) that includes at least two hydroxyl groups on each binder molecule, and is usually applied via rotogravure. The 2-component polyol/polymer isocyanate ink/OPV does not require an elevated temperature to initiate or otherwise assist in the reaction of the hardener and binder. When an article printed with the 2-component polyol/polymer isocyanate ink/OPV is stored at room temperature for up to about seven days following printing, or between about 64 degrees Fahrenheit and about 81 degrees Fahrenheit, the crosslinking reaction between the hardener and binder will be substantially complete. The amount of time required for the crosslinking reaction to become substantially complete varies with the type of 2-component system. For example, the crosslinking reaction for a 2-component matte varnish is typically complete within five days, whereas the crosslinking reaction for a gloss varnish may take as much as seven to fourteen days to become substantially complete.

The term “substantially complete” as used herein means that the crosslinking reaction is sufficiently complete to provide the desired physical properties, such as chemical resistance, heat resistance and scuff resistance, of the printed surface of the article. For example, when the crosslinking reaction of the two-component coating on a printed article produced according to embodiments of the invention is substantially complete, the coating will have a heat resistance of at least 400 degrees Fahrenheit and a scuff resistance of at least 1000 rubs on a Sutherland ink rub tester with a four pound weight.

Although it is possible to store the articles at temperatures as high as about 140 degrees Fahrenheit to speed up the curing reaction, it is not necessary for the 2-component ink/OPV to substantially completely react and thus obtain the desired physical properties. The fact that this 2-component ink/OPV is not a thermoset system is advantageous for article substrates such as polymeric films because the high substrate surface temperatures required to initiate curing of a thermoset system are typically detrimental to the structural integrity of the polymeric substrate. In addition, to achieve the required high substrate surface temperatures, the residence time of the printed article in the tunnel dryer could become the speed limiting factor of the printing process, or alternatively, a longer tunnel would be required.

It was believed that this 2-component ink/OPV could not be applied via the flexographic printing process because it is an acetate-borne system. In particular, inks and coatings containing ester- or ketone-based solvents as their primary solvents are generally incompatible with current rollers and plates used in flexographic printing, typically causing the rollers and plates to degrade and/or swell in volume. Photopolymers are often employed to form flexographic rollers and plates, but are incompatible with esters such as acetate, readily degrading when exposed to acetate-based inks and varnishes. Another common material for flexographic rollers and plates is rubber. There are various types of elastomeric materials that may be used in rubber rollers and plates, and rubber rollers and plates including polar polymers are susceptible to swelling when exposed to polar solvents, such as solvents containing acetates or ketones.

Solutions that are reactive with hydroxyl groups, for example 2-component polyol/polyisocyanate inks/OPVs, will be referred to herein as “non-hydroxyl compatible” solutions, because the introduction of any hydroxyl groups, except for the two or more hydroxyl groups present on each polyol molecule, would interfere with the desired reactions and/or properties of the solutions. Hence, such reactive solutions are not compatible with other materials that also contain hydroxyl groups.

### SUMMARY OF THE INVENTION

The invention may be embodied in various forms.

In a first embodiment, a non-polar polymeric coating roller or plate, which is optionally impregnated with silicone, is used to apply a 2-component non-hydroxyl compatible OPV to the substrate. The roller can be overall or it can be laser engraved to apply the 2-component OPV with a pattern. The substrate can be unprinted or it can be printed with conventional flexographic inks applied with conventional flexographic plates via the flexographic printing process prior to the OPV application.

In another embodiment, a non-polar rubber coating roller that is optionally impregnated with silicone is used to apply a 2-component non-hydroxyl compatible primer, also called an under-lacquer, to the substrate. Once the primer/under-lacquer is applied the material can remain unprinted or it can be printed with conventional flexographic inks applied with conventional flexographic plates via the flexographic printing process.

In another embodiment, a non-polar polymeric coating roll that is optionally impregnated with silicone, is laser engraved with an image. This is then used to apply a 2-component non-hydroxyl compatible colored ink via the flexographic printing process to the substrate.

In a further embodiment, the 2-component ink is applied as described in paragraph [15] and a 2-component acetate based OPV is applied as described in paragraph [13] to the substrate via the flexographic printing process.

In another embodiment, a printed article is prepared by the flexographic printing process by applying a non-hydroxyl compatible varnish or ink to an article substrate using a flexographic roller comprising non-polar polymers and optionally impregnated with silicone.

In another embodiment, an apparatus for flexographic printing may be used both with non-hydroxyl compatible inks or varnishes and with inks or varnishes compatible with hydroxyl groups. The apparatus may include pumps, viscosity meters, viscosity controllers and washing systems that are dedicated to either non-hydroxyl compatible solutions or solutions that contain hydroxyl groups in any of the components, such as in a solvent of alcohol or water.

In a still further embodiment, a printed article is prepared onto which more than one type of coating is pattern applied by a flexographic process. Unique patterns are laser engraved onto two or more flexographic rollers/plates made of non-polar polymers and optionally impregnated with silicone. The patterns are designed such that they may each coat different portions of an article substrate surface. Other features and advantages of the invention will become apparent to those skilled in the art upon review of the following detailed description, claims and drawings.

### BRIEF DESCRIPTION OF THE FIGURES

FIG. 1 is a perspective view of an article prepared by a flexographic process of an embodiment.

FIG. 2 is a perspective view of another article prepared by a flexographic process of an embodiment.

FIG. 3 is a side view of an apparatus for flexographic printing according to an embodiment.

FIG. 4 is a side view of a portion of an apparatus for flexographic printing according to an embodiment.

### DETAILED DESCRIPTION OF THE INVENTION

Aspects of the invention are directed to flexographic printing methods utilizing rollers or plates that can withstand non-hydroxyl compatible ink and coatings, such as OPV systems. As discussed above, the term “non-hydroxyl compatible” refers to solutions in which hydroxyl groups, such as those found in alcohols or water, would interfere with the hardening or curing of the solution to be applied to a substrate. For example, in a two-component ink or varnish that contains isocyanate groups, a chemical reaction would occur between alcohol groups and the isocyanate groups to result in the formation of a gel-like precipitate and prevent the ink or varnish from instead crosslinking with the component that contains hydroxyl groups, and curing properly.

Aspects of the present invention are directed to the use of rollers or plates comprised of non-polar polymers, in flexographic printing methods. In particular, such rollers/plates will hold up without deteriorating when exposed to the non-hydroxyl compatible solutions, such as acetate-based inks. Further, swelling of such rollers/plates is minimal upon exposure to the non-hydroxyl compatible inks or varnishes. In certain embodiments, the flexographic rollers or plates comprise rubber. The term “rubber” as used herein refers to elastomeric materials, such as polymerized unsaturated hydrocarbons or copolymerized hydrocarbons.

Aspects of the present invention are further directed to flexographic printing methods utilizing two-component inks and/or varnishes or coatings.

Further aspects of the invention are directed to surface printing flexible packages with over print coatings to obtain packages that will withstand over a thousand rubs on a Sutherland ink rub tester with a four pound weight, and heat resistance up to 575° F.

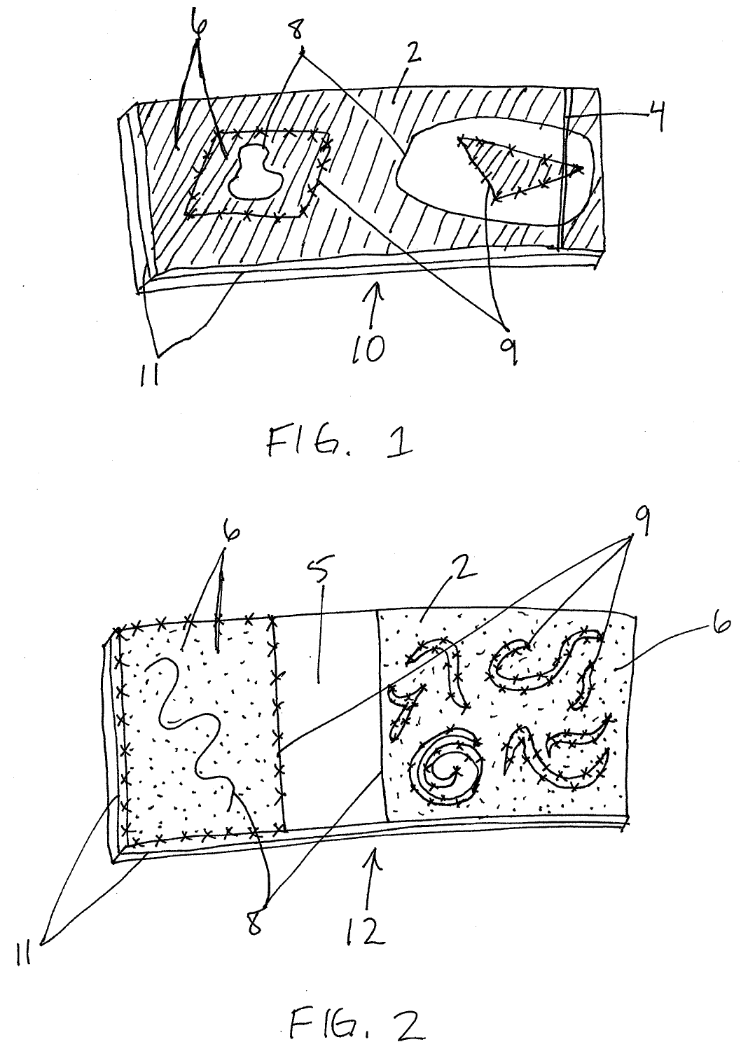

Referring to the drawings, wherein like numbers refer to like elements, FIG. 1 shows a printed article 10 prepared by a flexographic process. In one embodiment the printed article 10 may be formed into a flexible package comprising a seal 11 around the perimeter of the article 10. The seal 11 may be formed by heat sealing methods or ultrasonic sealing methods, for example. In an embodiment, a flexible package produced with the article 10 may also comprise a closure 4. The closure 4 may be configured such that a user is capable of repeatedly opening and closing an end of the article 10.

The printed article 10 has an outer surface 2, on which one or more patterns of ink 6 have been coated. The article 10 also comprises a first coating pattern 8 that has been pattern applied by a first flexographic roller or plate comprising non-polar polymers. In an embodiment, the flexographic roller or plate is acetate-resistant. Similarly, the article 10 further comprises a second coating pattern 9 that has been pattern applied by a second flexographic roller/plate containing non-polar polymers. The printed article 10 of embodiments of the present invention may comprise one or more non-hydroxyl compatible coating patterns over the portion of the article that includes the closure 4. The use of certain solutions, such as high heat resistant two-component solutions comprising a polyol/polyisocyanate system, allows the incorporation of such closure features to the article 10 without damaging the integrity of the printing on the outer surface 2 of the article 10.

In certain embodiments of the invention, one of the coating patterns 8 or 9 comprises a high gloss varnish while the other comprises a matte varnish. In alternate embodiments, the coating patterns 8 and 9 comprise texture over print varnish, high coefficient of friction coatings, medium coefficient of friction coatings, low coefficient of friction coatings, high gloss varnish, matte varnish, and/or other suitable coatings. Texture over print varnish may be prepared by adding standard texturizing resins or other additives known in the art, to a varnish.

The coefficient of friction of coatings may be measured by ASTM method D1894. High coefficient of friction coatings employed in embodiments of the invention preferably have a kinetic coefficient of friction of about 0.45 and up. Further, medium coefficient of friction coatings preferably have a kinetic coefficient of friction between about 0.26 and 0.45, while low coefficient of friction coatings may have a kinetic coefficient of friction between about 0.10 and 0.25.

The extent of gloss of a varnish is unitless and may be determined on a 60° BYK Glossmeter according to ASTM method D523. High gloss varnishes used in certain embodiments of the present invention may be 40 and above, and mid-range gloss varnishes are preferably between about 21-39. Very low gloss varnishes are typically referred to as “matte” varnishes and are preferably between about 0-20.

Any combination of desired ink patterns 6 and/or coating patterns 8 and 9 may be applied to the printed article 10, according to various embodiments of the invention. Without wishing to be bound by theory, it is believed that the non-hydroxyl compatible coatings, in particular two-component coatings, migrate into the ink and may chemically bond or physically interact with the ink to provide a strong coating once the reaction is substantially complete, typically in less than approximately five to seven days.

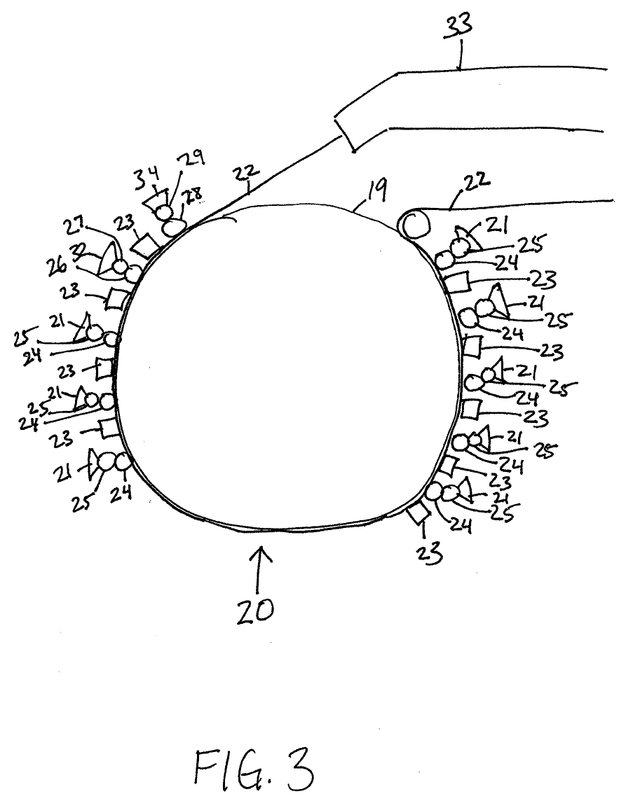

Referring to FIG. 2, a printed article 12 is shown on which one or more ink patterns 6 have been printed. In contrast, the article 12 also includes an area 5 excluding printed ink. When the article 12 is comprised of transparent polymeric material, the area 5 may provide an area that remains transparent to allow viewing through the article 12. The printed article 12 also comprises a first coating pattern 8 and a second coating pattern 9 on the outer surface 2 of the article 12. As illustrated in FIG. 2, the patterns 8 and 9 may be interspersed with each other to present a varied appearance, for example a coating pattern 8 of high gloss varnish and a coating pattern 9 of matte varnish. Any combination of ink patterns 6, areas without ink 5, first coating pattern 8 and second coating pattern 9 may be employed to provide a desired appearance and texture on the outer surface 2 of the article. Of course, additional coatings may also be pattern applied onto the article 12 by additional flexographic rollers/plates comprising non-polar polymers, in any design.

An article printed with non-hydroxyl compatible inks and varnishes exhibits strong scuff resistance. In particular, the scuff resistance may be tested according to a Sutherland rub test using a Sutherland ink rub tester, available from Testing Machines, Inc., Amityville, N.Y. In a Sutherland rub test, a printed article is affixed to the base of the test equipment and another material is affixed to a four pound weight. Next, the material is rubbed across the printed surface of the article a specific number of times with a force of four pounds. For example, the material may be another piece of the printed article, or alternatively, corrugated cardboard. To test the scuff resistance of a printed article with respect to four pounds concentrated in a small area, the material may be affixed to a button on the four pound weight and then the material on the button is rubbed across the printed article. In certain embodiments, the article 10 will withstand over a thousand rubs without exhibiting damage to the printed surface of the article.

An article printed with non-hydroxyl compatible inks and varnishes may exhibit strong heat resistance. In particular, the heat resistance may be tested by subjecting the printed article to an elevated temperature, such as over 500 degrees Fahrenheit, under pressure for a specific amount of dwell time. The pressure applied may be 40 psi, for example, and the dwell time may be about 1-2 seconds. Prior to exposure to the high temperature and pressure, the printed article is folded so that the printed surface comes into contact with itself, to determine if the printing will stick to itself or not. Printed articles according to embodiments of the invention that were subjected to temperatures up to 575 degrees Fahrenheit at 40 psi for one second did not exhibit sticking of the printed surface to itself and thus exhibited heat resistance of up to 575 degrees Fahrenheit.

FIG. 3 illustrates a flexographic printing apparatus 20, which comprises a large central impression drum 19 and a plurality of sets of ink or coating chambers 21, metal or ceramic anilox rollers 25, flexographic rollers/plates 24 and between deck dryers 23 disposed around an outer surface of the central impression drum 19. The combination of one ink chamber 21, one anilox roller 25 and one flexographic roller/plate 24 comprise one printing deck. In operation, the anilox rollers 25 pick up ink from the ink chambers 21 within microscopic cells (not shown) disposed on the anilox rollers 25. The anilox rollers 25 transfer the ink to the flexographic rollers/plates 24 such that a specific, uniform thickness of ink is disposed on an outer surface of the flexographic rollers/plates 24. One printing deck is used for each ink or coating printed or coated onto an article substrate 22. The anilox roller 25 and flexographic rollers/plate 24 for each printing deck are positioned at a predetermined distance from each other to provide the most effective ink transfer between the rollers.

The apparatus 20 is configured to allow an article substrate 22 to be positioned between the outer surface of the drum 19 and the flexographic roller/plates 24. In operation, the article substrate 22 is passed between the drum 19 and the flexographic rollers/plates 24, and inks or coatings may be applied to the article substrate 22 by the action of the coated roller/plates 24 pressing the article substrate 22 against the drum 19. The between deck dryers 23 are located adjacent to the drum 19 in between each printing deck and may be each set to apply heat to the article substrate 22 to dry the ink or coating that was just applied to the article substrate 22 prior to having another coating of ink or varnish printed on the substrate 22.

The apparatus 20 further comprises a first coating chamber 32, a first anilox roller 27 and a first flexographic roller/plate 26 comprising non-polar polymers. In an embodiment, the flexographic roller/plate 26 comprises silicone-impregnated rubber. Similar to the sets of rollers described above, the first anilox roller 27 and the first flexographic roller/plate 26 are positioned at a specific distance from each other to provide an effective transfer of non-hydroxyl compatible coating material between the rollers. The flexographic rollers/plates 24 and 26 may be overall or they may be engraved with a pattern. In one embodiment, the flexographic rollers/plates 24 and 26 are engraved with a plurality of designs that each provides at least one area, in the same relative location on each of the roller/plates 24 and 26, that excludes inks and coatings. Accordingly, once the plurality of inks or coatings have been applied to the outer surface of an article substrate 22, at least one area on the article substrate 22 remains free of printing/coating. Polymeric or rubber rollers previously used for flexographic printing typically degrade or swell in size when used with non-hydroxyl compatible inks or coatings, which typically contain ester- or ketone-based solvents, either of which would interfere with the proper transfer of material between adjacent rollers.

Rollers or plates that hold up to solutions other than alcohol-based or water-based inks/OPV may be obtained from any suitable source. Such rollers/plates may, for example, be made of rubber comprising non-polar polymers and may be silicone-impregnated to provide good coating release of the inks and OPVs from the rollers/plates. Any suitable rollers or plates that can hold up to the solvents used with non-hydroxyl compatible solutions are contemplated. For example, non-polar rollers/plates that include polymers with ethylene and propylene units may be employed, or rollers/plates comprising a copolymer of isobutylene and isoprene. Suitable silicone-impregnated rollers may be obtained from Valley Roller in Appleton, Wis. marketed under the name of “Thermasil”. Although silicone impregnated rollers are commercially available, such rollers are not believed to have been previously used to apply inks or coatings in a flexographic process or an offset gravure process.

A non-hydroxyl compatible coating, such as an acetate-based coating, may be applied by the first flexographic roller/plate 26 to substantially cover the surface of an article substrate, or a coating may be pattern applied by using an engraved flexographic roller/plate. In addition, a second engraved non-polar polymeric flexographic roller/plate 28 may be included on the apparatus to provide a different coating pattern to the substrate from the first pattern. In such an embodiment, the apparatus also comprises a second coating chamber 34 and a second coating roller 29 to transfer the coating to the flexographic roller/plate 28.

Once the article substrate 22 has passed through all of the sets of flexographic roller/plates 26 and 28, it may be then passed through a tunnel dryer 33 to complete the drying of all of the layers of ink and varnish applied to the substrate 22. In certain embodiments, the tunnel dryer 33 comprises multiple zones (not shown) that are each set to a different temperature. For example, the temperature may increase within the dryer 33 as the article substrate progresses through the zones of the tunnel dryer 33.

Alternatively, the apparatus may be configured in accordance with older known flexographic systems, such as comprising a plurality of sets of ink pans, fountain rollers, meter rollers and flexographic rollers/plates, which are disposed around an outer surface of the central impression drum. In such an embodiment, the fountain rollers pick up ink from the ink pans and transfer the ink to the meter rollers. The meter rollers then meter the ink on the flexographic rollers/plates such that a specific, uniform thickness of ink is disposed on an outer surface of the flexographic rollers/plates. Of course, other known flexographic systems may also be employed with embodiments of the invention, including, but not limited to, in-line presses and stack presses.

In a further embodiment, the apparatus may be configured in accordance with an offset gravure system, comprising a plurality of sets of ink pans, rotogravure rollers and flexographic rollers/plates, which are disposed around an outer surface of the impression drum. The rotogravure rollers may be smooth or engraved with a pattern. In such an embodiment, the gravure rollers pick up ink from the ink pans and transfer the ink to the flexographic roller/plate such that a coating/ink or coating/ink pattern is applied to an article substrate.

Typical flexographic printing apparatuses include built-in systems for pumping inks and coatings from reservoirs to the ink or coating chambers and back to the reservoirs. Viscometers are also disposed in fluid communication with the reservoirs to monitor the viscosity of the ink or coating. If the viscosity of the ink or coating is outside of a predetermined range, the viscosity is adjusted, usually by adding solvent to the ink or coating. Generally, a viscosity between about 20-38 seconds, as measured on either a Signature or General Electric #2 Zahn Cup, is used in flexographic printing with standard inks and coatings. (This corresponds to a viscosity of approximately 30-90 centipoise.) In an embodiment, the viscosity of standard flexographic inks and coatings is between about 25-33 seconds (50-78 centipoise). Washing components are further built in to the apparatuses to clean out the systems following each printing run to prevent inks and coatings from drying within the systems.

The solvents for inks and coatings typically used in flexographic printing include alcohols and/or water, which are incompatible with certain inks and coatings. For instance, a chemical reaction between the alcohol groups and the isocyanate groups of the Siegwerk two-component inks and coatings results in the formation of a gel-like precipitate and prevents the ink or varnish from crosslinking and curing properly. Although the flexographic apparatuses are cleaned between each use, some residual hydroxyl groups remain in the system. Thus, if the same system were to be used for both types of inks and coatings, there would be a substantial likelihood that the inks or coatings would react with the hydroxyl groups and precipitate within the system. To prevent such a chemical reaction and the possibility of clogging up the system, separate pumps, viscometers, ink/coating chambers, rollers and washing components should be used for each of the two types of inks/coatings.

In one embodiment, the apparatus 20 is configured to perform flexographic printing with both standard flexographic inks and coatings as well as with non-hydroxyl compatible inks and coatings. The apparatus 20 comprises at least two sets of each of the components that can come into contact with the ink or coating used for printing. The various components may be built into the interior of the apparatus 20, located external to the apparatus 20, or a combination thereof.

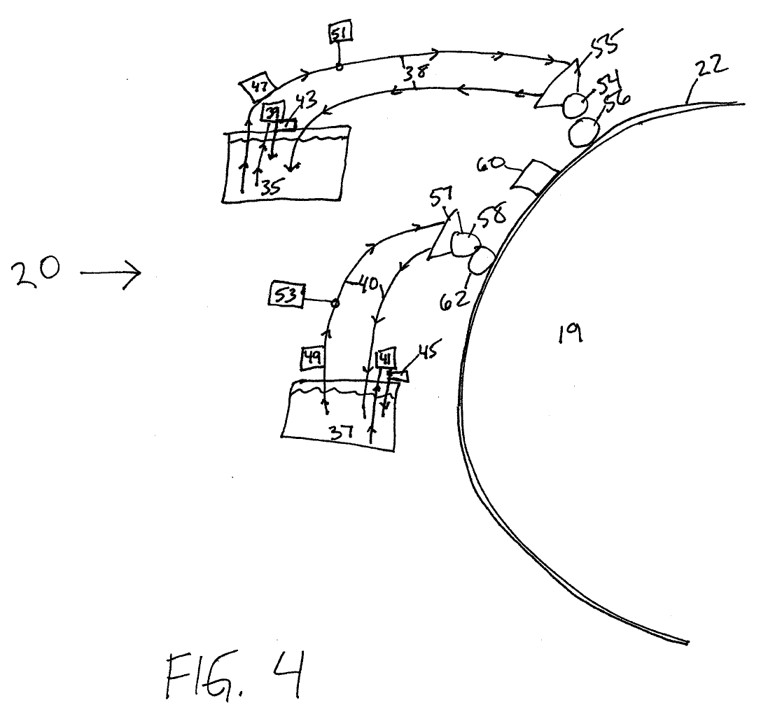

Referring to FIG. 4, the apparatus 20 comprises a first set of components designated for use with standard flexographic inks and coatings, including an ink/coating reservoir 35 to hold a batch of ink or coating. A viscometer 39 is disposed in fluid connection with the reservoir 35 and a viscosity controller 43. The viscosity controller 43 is configured to inject additional solvent into the ink or coating if the viscometer 39 determines that the viscosity is above a predetermined level. The first set of components further comprises a pump 47 that pumps the ink or coating through tubing 38 from the reservoir 35 to the ink/coating chamber 55. Any suitable anilox roller 54 and flexographic roller/plate 56 may be employed in the first set of components to print on a substrate.

In addition, the first set of components includes a washer 51, for either manual or automatic washing of the tubing and components with which the ink or coating comes into contact. The washer 51 may be in fluid communication with the tubing 38, and typically, the washer 51 is employed after the end of a printing run to ensure that no ink or coating residue dries inside the apparatus components. For standard flexographic inks and coatings, an alcohol-based solution may be used with the washer 51.

The apparatus 20 also includes a second set of components for use with non-hydroxyl compatible flexographic inks and coatings, such as a polyol/polyisocyanate two-component ink or over print varnish. Similar to the first set of components, the second set comprises a pump 49 that pumps ink or coating from a reservoir 37 through solvent-resistant tubing 40 to an ink/coating chamber 57. Optionally, the ink or coating is sampled by a viscometer 41, and a viscosity controller 45 may add solvent to the ink or coating in the reservoir 37 as needed. Alternatively, the viscosity may be measured and adjusted manually. The viscosity of the non-hydroxyl compatible inks and coatings may range between about 17-28 seconds as measured on a Signature or General Electric #2 Zahn Cup (15-63 centipoise). In an embodiment, the viscosity is between about 21-26 seconds (35-55 centipoise).

Similar to the rollers described above, an anilox roller 58 and a flexographic roller/plate 62 cooperate to apply the non-hydroxyl compatible ink or coating to an article substrate. The flexographic roller/plate 62 must comprise a material resistant to the ink or coating solvent, such as a non-polar polymer. In certain embodiments, the flexographic roller/plate 62 comprises a silicone-impregnated non-polar rubber material. A dryer 60 may also be included in the apparatus adjacent the drum 19 to dry the coating applied by the flexographic roller/plate 62 prior to applying any further inks or coatings.

The second set of components may further comprise a washer 53 to remove any remaining non-hydroxyl compatible ink or coating from the portions of the apparatus with which the ink or coating comes into contact. In certain embodiments, the washer 53 may be in fluid communication with the tubing 40 and may be configured to clean the tubing 40, optional viscometer 41, optional viscosity controller 45, pump 49 and ink/coating chamber 57. Alternatively, the second set of components may be manually washed, for instance with an acetate-based cleaning solution.

In operation, one or both of the first and second sets of components are employed to print standard flexographic inks/coatings and/or non-hydroxyl compatible inks/coatings on an article substrate. This is accomplished without the risk of mixing the incompatible compositions and potentially harming the components of the apparatus by segregating the two types of ink/coatings into the separate first and second sets of components. The apparatus 20 may include any number of component sets to provide flexographic printing capabilities with a plurality of inks and coatings that are incompatible with each other.

In an embodiment, a flexographic process for printing an article is performed by applying a solution, such as an ink or coating that comprises acetate, to an article substrate using an acetate-resistant rubber flexographic roller/plate 62. Examples of suitable acetate-based inks include 2-component ink/OPV available from Siegwerk, comprising polyisocyanate that undergoes crosslinking by polyvinyl chlorides, modified to contain two or more hydroxyl groups, into polyurethane units. Typically, any suitable ink, such as inks comprising nitrocellulose, polyamide, and/or polyurethane resins may be employed in embodiments of the invention.

In certain embodiments, the flexographic roller/plate 62 is impregnated with silicone, which provides an improved release of the ink or coating from the roller/plate to the substrate, as compared to a rubber flexographic roller/plate that is not impregnated with silicone. Optionally, the flexographic process may be performed using the apparatus 20.

Based on the types of film or other substrates to be printed on as well as the physical requirements for the package, one and two component inks are combined with or without the OPV to create a superior quality printed package using the more economical flexography printing methods. Suitable substrates include, without limitation, polymeric film, paper, aluminum foil and folded cartons.

The flexographic printing method in accordance with the present invention can be utilized for any type of coating such as, but not limited to, high gloss varnish, mid-range gloss varnish, matte varnish, high coefficient of friction coating, medium coefficient of friction coating, low coefficient of friction coating, and texture over print varnish.

### EXAMPLES

The following examples are illustrative of embodiments of the present invention, as described above, and are not meant to limit the invention in any way. As noted above, articles made by the flexographic processes of the invention may comprise different substrates, such as polymeric film, paper, aluminum foil and folded cartons. Examples 1 through 11 below provide a few illustrative products that may be produced by embodiments of the flexographic process described herein. Material amounts reported in units of “pounds per ream” refer to the dry weight of the material.

Examples 12 through 30 below describe physical testing, including heat and abrasion resistance testing of articles made by the flexographic processes of the invention.

### Example 1

An article printed on a flexographic press, having a two-component non-hydroxyl compatible varnish applied with a non-polar polymeric flexographic roller/plate comprising ethylene and propylene polymers and impregnated with silicone. The article comprised the materials provided in Table 1 below.

TABLE 1

| Material | Amount | |
|---|---|---|
| Gloss Two-Component | 0.7-1.1 | pounds per ream |
| Polyol/Polymer Isocyanate | | |
| Varnish | | |
| Ink | 0.8-1.4 | pounds per ream |
| Polyethylene Terephthalate | 0.48 | mils |
| Polyethylene Imine | wash coat | |
| Extrusion Primer | | |
| Low Density Polyethylene | 8-11 | pounds per ream |
| Barrier Sealant Film | 1.75 | mils |

### Example 2

An article printed on a flexographic press, having two two-component non-hydroxyl compatible varnishes that were each pattern applied with a non-polar polymeric flexographic roller/plate comprising ethylene and propylene polymers. The article comprised the materials provided in Table 2 below.

TABLE 2

| Material | Amount | |
|---|---|---|
| Matte Two-Component | 0.7-1.1 | pounds per ream |
| Polyol/Polymer Isocyanate | | |
| Varnish | | |
| Gloss Two-Component | 0.7-1.1 | pounds per ream |
| Polyol/Polymer Isocyanate | | |
| Varnish | | |
| Ink | 0.8-1.4 | pounds per ream |
| Polyethylene Terephthalate | 0.48 | mils |
| Polyethylene Imine | wash coat | |
| Extrusion Primer | | |
| Low Density Polyethylene | 8-11 | pounds per ream |
| Barrier Sealant Film | 1.75 | mils |

### Example 3

An article printed on a flexographic press, having a two-component non-hydroxyl compatible varnish applied with a non-polar polymeric flexographic roller/plate comprising ethylene and propylene polymers and impregnated with silicone. The article comprised the materials provided in Table 3 below.

TABLE 3

| Material | Amount | |
|---|---|---|
| Gloss Two-Component | 1.5 | pounds per ream |
| Polyol/Polymer Isocyanate | | |
| Varnish | | |
| Ink | 1.0 | pounds per ream |
| High Slip Sealant Film | 2.5 | mils |

### Example 4

An article printed on a flexographic press, having a two-component non-hydroxyl compatible varnish applied with a non-polar polymeric flexographic roller/plate comprising ethylene and propylene polymers and impregnated with silicone. The article comprised the materials provided in Table 4 below.

TABLE 4

| Material | Amount | |
|---|---|---|
| Gloss Two-Component | 1.0-1.5 | pounds per ream |
| Polyol/Polymer Isocyanate | | |
| Varnish | | |
| Ink | 0.8-1.4 | pounds per ream |
| Paper | 35 | pounds per ream |
| Low Density Polyethylene | 10 | pounds per ream |
| Aluminum Foil | 0.30 | mils |
| Ethylene Acrylic Acid/Low | 15 | pounds per ream |
| Density Polyethylene | | |
| Coextrusion | | |

### Example 5

An article printed on a flexographic press, having a two-component non-hydroxyl compatible varnish applied with a non-polar polymeric flexographic roller/plate comprising ethylene and propylene polymers. The article comprised the materials provided in Table 5 below.

TABLE 5

| Material | Amount | |
|---|---|---|
| Gloss Two-Component | 1.0-1.5 | pounds per ream |
| Polyol/Polymer Isocyanate | | |
| Varnish | | |
| Ink | 0.8-1.4 | pounds per ream |
| Paper | 24 | pounds per ream |
| Low Density Polyethylene | 10 | pounds per ream |
| Aluminum Foil | 0.30 | mils |
| Ethylene Acrylic Acid/Low | 15 | pounds per ream |
| Density Polyethylene | | |
| Coextrusion | | |

### Example 6

An article printed on a flexographic press, having a two-component non-hydroxyl compatible varnish applied with a non-polar polymeric flexographic roller/plate comprising ethylene and propylene polymers. The article comprised the materials provided in Table 6 below.

TABLE 6

| Material | Amount | |
|---|---|---|
| Matte Two-Component | 0.7-1.1 | pounds per ream |
| Polyol/Polymer Isocyanate | | |
| Varnish | | |
| Ink | 0.8-1.4 | pounds per ream |
| Polyethylene Terephthalate | 0.48 | mils |
| Polyethylene Imine | wash coat | |
| Extrusion Primer | | |
| Low Density Polyethylene | 8-11 | pounds per ream |
| Biaxially Oriented | 0.55 | mils |
| Polypropylene | | |
| Ethylene Vinyl Acetate | 28 | pounds per ream |

### Example 7

An article printed on a flexographic press, having a two-component non-hydroxyl compatible varnish applied with a non-polar polymeric flexographic roller/plate comprising ethylene and propylene polymers and impregnated with silicone. The article comprised the materials provided in Table 7 below.

TABLE 7

| Material | Amount | |
|---|---|---|
| Matte Two-Component | 0.7-1.1 | pounds per ream |
| Polyol/Polymer Isocyanate | | |
| Varnish | | |
| Ink | 0.8-1.4 | pounds per ream |
| Polyethylene Terephthalate | 0.36 | mils |
| Polyethylene Imine | wash coat | |
| Extrusion Primer | | |
| Low Density Polyethylene/ | 7.2 | pounds per ream |
| Ethylene Vinyl Alcohol/ | | |
| Low Density Polyethylene | | |
| Coextrusion | | |
| Biaxially Oriented | 0.55 | mils |
| Polypropylene | | |
| Ethylene Vinyl Acetate | 21 | pounds per ream |

### Example 8

An article printed on a flexographic press, having a two-component non-hydroxyl compatible varnish applied with a non-polar polymeric flexographic roller/plate comprising ethylene and propylene polymers and impregnated with silicone. The article comprised the materials provided in Table 8 below.

TABLE 8

| Material | Amount | |
|---|---|---|
| Gloss Two-Component | 1.5 | pounds per ream |
| Polyol/Polymer Isocyanate | | |
| Varnish | | |
| Ink | 1.0 | pounds per ream |
| Aluminum Foil | 2.00 | mils |
| Heat Seal Coating | 1.5 | pounds per ream |

### Example 9

An article printed on a flexographic press, having a two-component non-hydroxyl compatible under-lacquer coating applied with a non-polar polymeric flexographic roller/plate comprising ethylene and propylene polymers and impregnated with silicone. The article comprised the materials provided in Table 9 below.

TABLE 9

| Material | Amount | |
|---|---|---|
| Ink | 1.0 | pounds per ream |
| Gloss Two-Component | 1.0 | pounds per ream |
| Polyol/Polymer Isocyanate | | |
| Varnish | | |
| Aluminum Foil | 2.00 | mils |

### Example 10

An article printed on a flexographic press, having a two-component non-hydroxyl compatible ink applied with a non-polar polymeric flexographic roller/plate comprising ethylene and propylene polymers and impregnated with silicone. The article comprised the materials provided in Table 10 below.

TABLE 10

| Material | Amount | |
|---|---|---|
| Two-Component Polyol/ | 1.0 | pounds per ream |
| Polymer Isocyanate Ink | | |
| Three layer film of | 1.15 | mils |
| Polypropylene/Linear Low | | |
| Density Polyethylene/ | | |
| Ethylene Vinyl Acetate | | |

### Example 11

An article printed on a flexographic press, having a two-component non-hydroxyl compatible varnish applied with a non-polar polymeric flexographic roller/plate comprising ethylene and propylene polymers. The article comprised the materials provided in Table 11 below.

TABLE 11

| Material | Amount | |
|---|---|---|
| Gloss Two-Component | 0.8 | pounds per ream |
| Polyol/Polymer Isocyanate | | |
| Varnish | | |
| Ink | 1.0 | pounds per ream |
| Heat Sealable Polyethylene | 2.0 | mils |
| Terephthalate Lidstock | | |

### Example 12

Sample articles prepared according to flexographic processes of the invention were tested for heat resistance after more than seven days following the preparation of the articles. An article prepared according to Example 2, having two two-component varnishes printed on a polymeric substrate was folded in half such that the printed surface was placed in contact with itself. Next, the article was subjected to conditions of 515 degrees Fahrenheit temperature at a pressure of 40 psi for one second of dwell time. The printed surface of the article did not stick to itself, thus the article of Example 2 had a heat resistance of at least 515 degrees Fahrenheit. The article could not be heated above 515 degrees Fahrenheit without causing damage to the polymeric substrate, thus 515 degrees Fahrenheit was the highest heat resistance temperature that was tested on the article of Example 2.

### Example 13

An article prepared according to Example 1, after more than seven days following the preparation of the article and having a two-component varnish printed on a polymeric substrate was folded in half such that the printed surface was placed in contact with itself. Next, the article was subjected to conditions of 515 degrees Fahrenheit temperature at a pressure of 40 psi for one second of dwell time. The printed surface of the article did not stick to itself, thus the article of Example 1 had a heat resistance of at least 515 degrees Fahrenheit. The article could not be heated above 515 degrees Fahrenheit without causing damage to the polymeric substrate, thus 515 degrees Fahrenheit was the highest heat resistance temperature that was tested on the article of Example 1.

### Example 14

An article prepared according to Example 3, after more than seven days following the preparation of the article and having a two-component varnish printed on a polymeric substrate was folded in half such that the printed surface was placed in contact with itself. Next, the article was subjected to conditions of 400 degrees Fahrenheit temperature at a pressure of 40 psi for one second of dwell time. The printed surface of the article did not stick to itself, thus the article of Example 3 had a heat resistance of at least 400 degrees Fahrenheit. The article could not be heated above 400 degrees Fahrenheit without causing damage to the polymeric substrate, thus 400 degrees Fahrenheit was the highest heat resistance temperature that was tested on the article of Example 3.

### Example 15

An article prepared according to Example 4, after more than seven days following the preparation of the article and having a two-component varnish printed on a paper substrate was folded in half such that the printed surface was placed in contact with itself. Next, the article was subjected to conditions of 575 degrees Fahrenheit temperature at a pressure of 40 psi for one second of dwell time. Although the paper substrate became scorched, the printed surface of the article did not stick to itself. Thus the article of Example 4 had a heat resistance of at least 575 degrees Fahrenheit.

### Example 16

An article prepared according to Example 5, after more than seven days following the preparation of the article and having a two-component varnish printed on a paper substrate was folded in half such that the printed surface was placed in contact with itself. Next, the article was subjected to conditions of 575 degrees Fahrenheit temperature at a pressure of 40 psi for one second of dwell time. Although the paper substrate became scorched, the printed surface of the article did not stick to itself. Thus the article of Example 5 had a heat resistance of at least 575 degrees Fahrenheit.

### Example 17

An article prepared according to Example 8, after more than seven days following the preparation of the article and having a two-component varnish printed on an aluminum foil substrate was folded in half such that the printed surface was placed in contact with itself. Next, the article was subjected to conditions of 550 degrees Fahrenheit temperature at a pressure of 40 psi for one second of dwell time. The printed surface of the article did not stick to itself, thus the article of Example 8 had a heat resistance of at least 550 degrees Fahrenheit.

### Example 18

An article prepared according to Example 9, after more than seven days following the preparation of the article and having a two-component under-lacquer printed on an aluminum foil substrate was folded in half such that the printed surface was placed in contact with itself. Next, the article was subjected to conditions of 550 degrees Fahrenheit temperature at a pressure of 40 psi for one second of dwell time. The printed surface of the article did not stick to itself, thus the article of Example 9 had a heat resistance of at least 550 degrees Fahrenheit.

### Example 19

An article prepared according to Example 1, after more than seven days following the preparation of the article and having a two-component varnish printed on a polymeric substrate was subjected to 1000 rubs according to a Sutherland rub test, which consisted of rubbing the printed surface coating of the article against itself with four pounds of force on a Sutherland ink rub tester. Following the 1000 rubs, the printed surface showed no damage.

### Example 20

An article prepared according to Example 2, after more than seven days following the preparation of the article and having two two-component varnishes printed on a polymeric substrate was subjected to 1000 rubs according to a Sutherland rub test, which consisted of rubbing the printed surface coating of the article against itself with four pounds of force on a Sutherland ink rub tester. Following the 1000 rubs, the printed surface showed no damage. In contrast to the sample of Example 2, the printed surface of an article printed with a standard nitrocellulose-based coating that was subjected to just 100 rubs in accordance with the same rub test showed minor damage.

### Example 21

An article prepared according to Example 2, after more than seven days following the preparation of the article, was subjected to 100 rubs according to a Sutherland rub test in which the printed surface coating of the article was rubbed against corrugated cardboard for 100 cycles with a force of four pounds on a Sutherland ink rub tester. Following the test, the printed surface showed no damage. The printed surface of an article printed with a standard nitrocellulose-based coating that was subjected to the same rub test also showed no damage.

### Example 22

An article prepared according to Example 2, after more than seven days following the preparation of the article, was subjected to 50 rubs according to a Sutherland rub test in which the printed surface coating of the article was rubbed against corrugated cardboard attached to a button, for 50 cycles with a force of four pounds on a Sutherland ink rub tester. Following the test, the printed surface showed minor damage. In contrast to the above test results for the article of Example 2, the printed surface of an article printed with a standard nitrocellulose-based coating that was subjected to the same rub test showed severe damage.

### Example 23

An article prepared according to Example 3, after more than seven days following the preparation of the article and having a two-component varnish printed on a polymeric substrate was subjected to 2000 rubs according to a Sutherland rub test, which consisted of rubbing the printed surface coating of the article against itself with four pounds of force on a Sutherland ink rub tester. Following the 2000 rubs, the printed surface showed no damage.

### Example 24

An article prepared according to Example 4, after more than seven days following the preparation of the article and having a two-component varnish printed on a paper substrate was subjected to 1500 rubs according to a Sutherland rub test, which consisted of rubbing the printed surface coating of the article against itself with four pounds of force on a Sutherland ink rub tester. Following the 1500 rubs, the printed surface showed no damage.

### Example 25

An article prepared according to Example 5, after more than seven days following the preparation of the article and having a two-component varnish printed on a paper substrate was subjected to 1500 rubs according to a Sutherland rub test, which consisted of rubbing the printed surface coating of the article against itself with four pounds of force on a Sutherland ink rub tester. Following the 1500 rubs, the printed surface showed no damage.

### Example 26

An article prepared according to Example 8, after more than seven days following the preparation of the article and having a two-component varnish printed on an aluminum foil substrate was subjected to 2000 rubs according to a Sutherland rub test, which consisted of rubbing the printed surface coating of the article against itself with four pounds of force on a Sutherland ink rub tester. Following the 2000 rubs, the printed surface showed no damage.

### Example 27

An article prepared according to Example 9, after more than seven days following the preparation of the article and having a two-component varnish printed on an aluminum foil substrate was subjected to 2000 rubs according to a Sutherland rub test, which consisted of rubbing the printed surface coating of the article against itself with four pounds of force on a Sutherland ink rub tester. Following the 2000 rubs, the printed surface showed no damage.

### Example 28

An article prepared according to Example 2, after more than seven days following the preparation of the article and having two two-component varnishes printed on a polymeric substrate was subjected to 100 cycles of flexing according to the Gelbo flex test, which consisted of flexing the article at a temperature of 37 degrees Fahrenheit. The printed surface itself did not experience damage, although the polymeric substrate of the article exhibited signs of damage that resulted in a few pin-sized spots of damage in the printed surface.

### Example 29

The extent of gloss of an article prepared according to Example 5, after more than seven days following the preparation of the article and having a high gloss two-component varnish printed on a polymeric substrate, was tested on a 60° BYK Glossmeter, as determined according to ASTM method D523. The printed surface of a startup sample exhibited a gloss of 47.4, and the printed surface of a roll sample exhibited a gloss of 49.6. Both samples had a gloss above 40, which is the typical minimum for a high gloss material.

### Example 30

The coefficient of friction of articles prepared according to Example 5, after more than seven days following the preparation of the articles and having a high gloss two-component varnish printed on a polymeric substrate, was tested by ASTM method D1894, in which the printed surface was rubbed against another printed surface of each article prepared according to Example 5. The test was performed on three startup samples, which are printed articles prepared at the very beginning of the printing run, and on three roll samples, which are printed articles prepared near the end of the same printing run. The printed surface of the startup samples exhibited an average static coefficient of friction of 0.26 and an average kinetic coefficient of friction of 0.19. The printed surface of the roll samples exhibited an average static coefficient of friction of 0.23 and an average kinetic coefficient of friction of 0.17. Both samples had a coefficient of friction of between about 0.10 and 0.25, thus the surface coating of the article according to Example 5 has a low coefficient of friction.

While the invention has been described with respect to specific examples including presently preferred modes of carrying out the invention, those skilled in the art will appreciate that there are numerous variations and permutations of the above described systems and techniques that fall within the spirit and scope of the invention. It should be understood that the invention is not limited in its application to the details of construction and arrangements of the components set forth herein. Variations and modifications of the foregoing are within the scope of the present invention. It is also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

We claim:

1. A printed article prepared by a process comprising the steps of:
providing an article substrate;
providing a first solution comprising a plurality of components comprising a first component having at least two hydroxyl groups and a second component, the solution excluding hydroxyl groups from each of the plurality of components except the first component;
providing a first roller comprising non-polar polymers; and
applying the first solution to an outer surface of the article substrate with the first roller;
wherein the first solution has a viscosity of between about 17-28 seconds as measured on either a Signature or General Electric #2 Zahn Cup when the first solution is applied to the article substrate and wherein the first component and the second component undergo a crosslinking reaction that is substantially completed within seven days following the application of the first solution to the article substrate when the article is subjected to a temperature of between about 64 degrees Fahrenheit and about 81 degrees Fahrenheit during the step of applying and during the crosslinking reaction.

2. The printed article of claim 1, wherein the first roller comprises rubber impregnated with silicone.

3. The printed article of claim 1, wherein the process further comprises the steps of:
providing an ink;
providing a second roller; and
applying the ink to the outer surface of the article substrate with the second roller.

4. The printed article of claim 3, wherein the ink comprises hydroxyl groups.

5. The printed article of claim 3, wherein the first solution is an over print varnish and the step of applying the ink is performed prior to the step of applying the first solution.

6. The printed article of claim 3, wherein the first solution is an under-lacquer and the step of applying the ink is performed after the step of applying the first solution.

7. The printed article of claim 1, wherein the first solution is an ink.

8. The printed article of claim 1, wherein the first solution is a matte varnish.

9. The printed article of claim 8, wherein the matte varnish is pattern applied, and the process further comprises the steps of:
providing a high gloss varnish;
providing a third roller comprising a non-polar polymer and having a pattern engraved on a surface of the third roller; and
pattern applying the high gloss varnish to the outer surface of the article substrate with the third roller.

10. The printed article of claim 1, wherein the first solution is a high gloss varnish.

11. The printed article of claim 9, wherein the article comprises an area on the outer surface of the article substrate that excludes printed ink.

12. The printed article of claim 3, wherein the first roller has a pattern engraved on a surface of the roller and the first solution is pattern applied, the process further comprising the steps of:
providing a second solution, wherein the first solution and the second solution are independently selected from the group consisting of high gloss varnish, mid-range gloss varnish, matte varnish, high coefficient of friction varnish, medium coefficient of friction varnish, low coefficient of friction varnish, texture over print varnish and combinations thereof;
providing a third roller comprising a non-polar polymer and having a pattern engraved on a surface of the third roller; and
pattern applying the second solution to the outer surface of the article substrate with the third roller.

13. The printed article of claim 1, wherein the article substrate comprises a material selected from the group consisting of a polymeric film, a paper, an aluminum foil and a folded carton.

14. The printed article of claim 1, wherein the first solution is selected from the group consisting of high coefficient of friction varnish, medium coefficient of friction varnish, low coefficient of friction varnish, high gloss varnish, mid-range gloss varnish, matte varnish, texture over print varnish and combinations thereof.

15. The printed article of claim 1, wherein, following substantial completion of the crosslinking reaction, the article is capable of withstanding temperatures of at least 400 degrees Fahrenheit without damage to the printing on the outer surface.

16. The printed article of claim 1, wherein, following substantial completion of the crosslinking reaction, the article is capable of withstanding temperatures of at least 515 degrees Fahrenheit without damage to the printing on the outer surface.

17. The printed article of claim 1, wherein, following substantial completion of the crosslinking reaction, the article is capable of withstanding at least one thousand rubs of the printed surface of the article against itself with a force of four pounds on a Sutherland ink rub tester, without damage to the printing on the outer surface.

18. A process for printing an article comprising the steps of:
providing an article substrate;
providing a first solution comprising a plurality of components comprising a first component having at least two hydroxyl groups and a second component, the solution excluding hydroxyl groups from each of the plurality of components except the first component;
providing a first roller comprising non-polar polymers; and
applying the first solution to an outer surface of the article substrate with the first roller,
wherein the first solution has a viscosity of between about 17-28 seconds as measured on either a Signature or General Electric #2 Zahn Cup when the first solution is applied to the article substrate and wherein the first component and second component undergo a crosslinking reaction that is substantially completed within seven days following the application of the first solution to the article substrate when the article is subjected to a temperature between about 64 degrees Fahrenheit and about 81 degrees Fahrenheit during the step of applying and during the crosslinking reaction.

19. The process of claim 18, wherein the first roller comprises rubber impregnated with silicone.

20. The process of claim 19, further comprising the steps of:
providing an ink;
providing a second roller; and
applying the ink to the outer surface of the article substrate with the second roller.

21. The process of claim 20, wherein the first solution is an over print varnish and the step of applying the ink is performed prior to the step of applying the first solution.

22. The process of claim 20, wherein the first solution is an under-lacquer and the step of applying the ink is performed after the step of applying the solution.

23. The process of claim 18, wherein the first solution is an ink.

24. The process of claim 20, wherein the ink comprises hydroxyl groups.

25. The process of claim 20, wherein the first roller has a pattern engraved on a surface of the roller and the first solution is pattern applied, the process further comprising the steps of:
providing a high gloss varnish;
providing a third roller comprising a non-polar polymer and having a pattern engraved on a surface of the third roller; and
pattern applying the high gloss varnish to the article substrate with the third roller.

26. The process of claim 20, wherein the first roller has a pattern engraved on a surface of the roller and the first solution is pattern applied, the process further comprising the steps of:
providing a matte varnish;
providing a third roller comprising a non-polar polymer and having a pattern engraved on a surface of the third roller; and
pattern applying the matte varnish to the article substrate with the third roller.

27. The process of claim 19, wherein the first solution has a viscosity of between 21-26 seconds as measured on either a Signature or General Electric #2 Zahn Cup when the solution is applied to the article substrate.

28. The process of claim 18, wherein the article substrate comprises a material selected from the group consisting of a polymeric film, a paper, an aluminum foil and a folded carton.

29. The process of claim 18, wherein the first solution is selected from the group consisting of matte varnish, mid-range gloss varnish, high gloss varnish, high coefficient of friction varnish, medium coefficient of friction varnish, low coefficient of friction varnish, texture over print varnish and combinations thereof.

30. The process of claim 20, wherein the first roller has a first pattern engraved on a surface of the first roller and the second roller has a second pattern engraved on a surface of the second roller, wherein the first pattern comprises at least one area that excludes the first solution and the second pattern comprises at least one area that excludes the ink, and wherein the at least one area is disposed on the surface of the second roller in the same relative location that the at least one area is disposed on the surface of the first roller, thereby providing at least one area on the outer surface of the article substrate on which the first solution is excluded and on which the ink is excluded.

31. A printed article prepared by a flexographic process comprising the steps of:
providing an article substrate;
providing a solution comprising a plurality of components comprising a first component having at least two hydroxyl groups and a second component comprising isocyanate groups and having a viscosity of between about 21 and 26 seconds as measured on either a Signature or General Electric #2 Zahn Cup, the solution excluding hydroxyl groups from each of the plurality of components except the first component;
providing a roller comprising ethylene and propylene polymers; and
applying the solution to the article substrate with the roller.
